(19) United States
(12) Patent Application Publication
(10) Pub. No.: US 2012/0143890 A1
(43) Pub. Date: Jun. 7, 2012

(54) APPARATUS AND METHOD FOR DB CONTROLLING IN PORTABLE TERMINAL

(75) Inventor: Kook-Yeon LEE, Gyeonggi-do (KR)

(73) Assignee: SAMSUNG ELECTRONICS CO., LTD., Gyeonggi-Do (KR)

(21) Appl. No.: 13/309,704

(22) Filed: Dec. 2, 2011

(30) Foreign Application Priority Data
Dec. 3, 2010 (KR) 10-2010-0122576

(51) Int. Cl. G06F 17/30

(52) U.S. Cl. 707/758; 707/E17.005; 707/E17.044

(57) ABSTRACT

A method for providing a DataBase Management System (DBMS) service in a portable terminal having a limited memory includes, in response to DB search information input, determining a row which matches the DB search information, in at least one DB file; generating a virtual set comprising at least one row which matches the DB search information; and when the set comprises one row, generating a record set by extracting data relating to at least one row from the virtual set.

### CLAIM OF PRIORITY

The present application claims the benefit to a Korean patent application filed in the Korean Intellectual Property Office on Dec. 3, 2010, and assigned Serial No. 10-2010-0122576, the entire disclosure of which is hereby incorporated by reference.

### FIELD OF THE INVENTION

The present invention relates generally to an apparatus and a method for controlling a database in a portable terminal.

### BACKGROUND OF THE INVENTION

A DataBase Management System (DBMS) enables a user or an application to access data from a database (DB). Even when the user or the application does not recognize a storage location of the data, the DBMS manages and allows the access to the corresponding data.

When a portable terminal adopts the DBMS, the portable terminal generates a DB file as a table to provide to the DBMS. The table includes a field including at least one record.

The portable terminal extracts data corresponding to a search condition value of the user or the application from the table-type DB file.

However, when the portable terminal utilizes a low-performance DB such as Constant DB (CDB), the portable terminal cannot provide the DBMS service due to the simple table-type DB file. For example, to generate a DB file for a song of Album=“A”, Genre=dance, and Artist=Joe and a song of Album=“B”, Genre=ballad, and Artist=Tom using a limited DB, the portable terminal generates the DB file as the table which maps keys and values in a one-to-one manner as shown in Table 1.

TABLE 1

| index | key | value |
|---|---|---|
| 1 | Album | A |
| 2 | Genre | dance |
| 3 | Artist | Joe |
| 4 | Album | B |
| 5 | Genre | ballad |
| 6 | Artist | Tom |
| . | . | . |
| . | . | . |
| . | . | . |

When the DB file is generated as shown in Table 1, the portable terminal extracts the one-to-one value mapped to the key input by the user or the application. However, since the portable terminal cannot provide a conditional inquiry service using the DB file, the DBMS service is unavailable. For example, when the user searches for the condition “Album”, the portable terminal extracts “A” and “B”, but the portable terminal cannot provide the conditional inquiry service which requires the entire data of the Album “A”.

### SUMMARY OF THE INVENTION

To address the above-discussed deficiencies of the prior art, it is a primary aspect of the present invention to provide an apparatus and a method for providing a DBMS service using a DB file which maps keys and values in a one-to-one manner.

Another aspect of the present invention is to provide an apparatus and a method for providing a DBMS service in a portable terminal with a limited memory.

Yet another aspect of the present invention is to provide an apparatus and a method for providing a DBMS service using a DB file which maps keys and values in a one-to-one manner in a portable terminal.

Still another aspect of the present invention is to provide an apparatus and a method for providing a DBMS service in a portable terminal which uses a CDB-type DB.

A further aspect of the present invention is to provide an apparatus and a method for reducing memory consumption according to a DB file in a portable terminal which uses a CDB-type DB.

According to one aspect of the present invention, a method for providing a DataBase Management System (DBMS) service in a portable terminal having a limited memory, includes when DB search information is determined, determining a row which matches the DB search information, in at least one DB file; generating a set including at least one row which matches the DB search information; and when the set includes one row, generating a record set by extracting data relating to at least one row from the row in the set. The DB file is generated as a table which maps one key and one value in a one-to-one manner.

According to another aspect of the present invention, an apparatus for providing a DBMS service in a portable terminal having a limited memory includes a DB generation unit for generating at least one DB file for input data; a control unit for, when DB search information is determined, determining a row which matches the DB search information in the at least one DB file, generating a first set including at least one row which matches the DB search information, and when the first set includes one row, generating a record set by extracting data relating to at least one row from the row; and a storage unit for storing the at least one DB file generated by the DB generation unit, the first set, and the record set. The DB file is generated as a table which maps one key and one value in a one-to-one manner.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a diagram of a method for generating a DB file according to an exemplary embodiment of the present invention;

FIG. 2 is a diagram of a method for providing a DBMS service according to an exemplary embodiment of the present invention; and

FIG. 3 is a block diagram of a portable terminal according to an exemplary embodiment of the present invention.

Throughout the drawings, like reference numerals will be understood to refer to like units, components and structures.

### DETAILED DESCRIPTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention provide a technique for providing a DataBase Management System (DBMS) service using a DB file which maps keys and values in a one-to-one manner.

Hereinafter, it is assumed that a portable terminal having a limited memory uses the DB file which maps keys and values in a one-to-one manner.

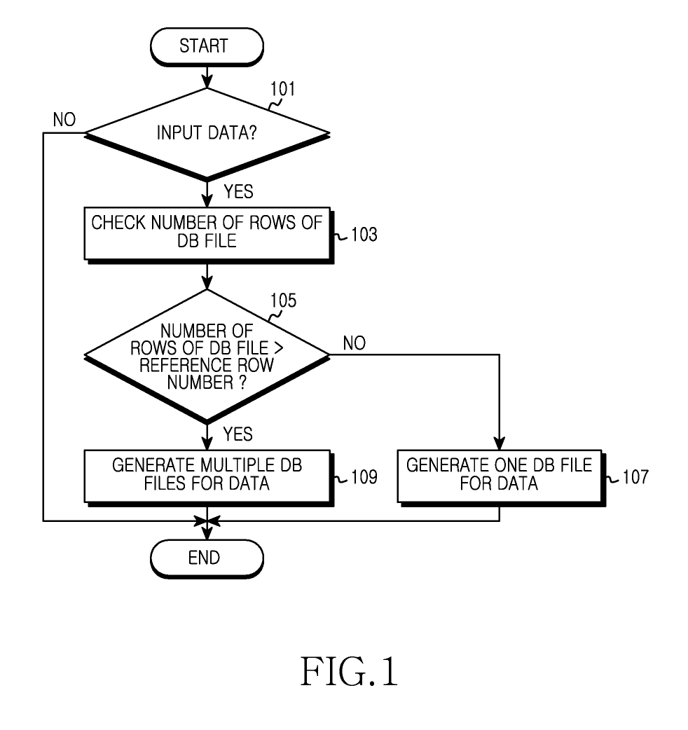

FIG. 1 illustrates a method for generating a DB file according to an exemplary embodiment of the present invention.

Referring to FIG. 1, in operation, the portable terminal checks whether data for generating the DB file is input in step 101. That is, the portable terminal determines whether a user inputs data for generating the DB file. Alternatively, the portable terminal determines whether an application inputs data for generating the DB file. Herein, the data includes keys and values of the DB discussed earlier with reference to Table 1.

If the data for generating the DB file is not input in step 101, the portable terminal finishes this process.

By contrast, when the data for generating the DB file is input, the portable terminal checks the number of the input data in step 103. That is, the portable terminal checks the number of rows in the DB file.

In step 105, the portable terminal compares the number of the rows of the DB file and a predetermined reference row number to determine whether to generate an additional DB file.

When the number of the rows of the DB file is smaller than or equal to the reference row number, the portable terminal recognizes that one DB file can be generated with the data input in step 101. Hence, in step 107, the portable terminal generates one DB file with the data input in step 101, as shown in Table 1.

If the number of the rows of the DB file is greater than the reference row number, the portable terminal recognizes that one DB file generated with the data input in step 101 is inadequate. Thus, in step 109, the portable terminal generates two or more DB files for the data input in step 101. For example, the portable terminal generates two or more DB files that resembles Table 1.

Thereafter, the portable terminal finishes this process.

As stated above, to reduce the DB file size, the portable terminal limits the number of the rows in one DB file. Thus, one DB file can be loaded using the limited memory capacity of the portable terminal.

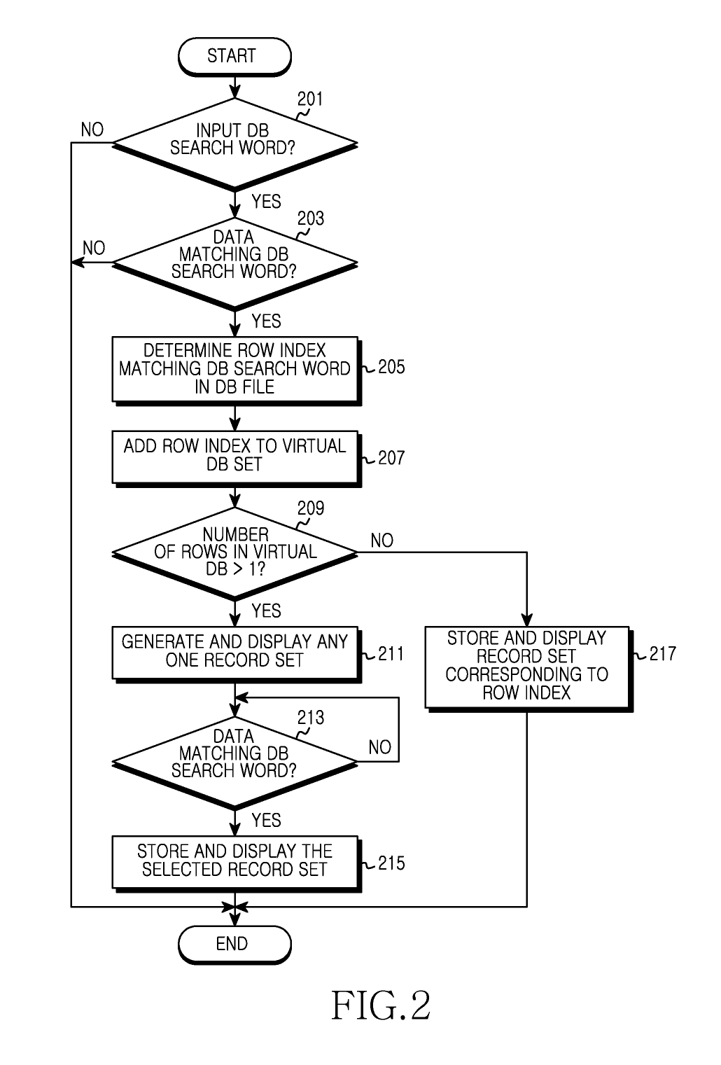

FIG. 2 illustrates a method for providing a DBMS service according to an exemplary embodiment of the present invention.

Referring to FIG. 2, the portable terminal checks whether DB search information is input in step 201. For example, the portable terminal determines whether the user inputs the DB search information. For example, the portable terminal determines whether the application inputs the DB search information.

When the DB search information is not input, the portable terminal finishes this process.

When the user or the application inputs the DB search information, the portable terminal determines whether at least one DB file stored therein includes the data which matches the DB search information in step 203.

When there is no DB file including the data matching the DB search information, the portable terminal finishes this process. In so doing, the portable terminal may display search failure information in a display unit.

By contrast, when at least one DB file contains the data matching the DB search information, the portable terminal determines a row index of the data that matches the DB search information in the DB file in step 205. When a plurality of DB files contains the data matching the DB search information, the portable terminal determines the row index of the data matching the DB search information for each DB file.

In step 207, the portable terminal adds the row index determined in step 205, to a virtual DB set. For example, when the DB file is generated as shown in Table 1 and the DB search information is “Album=A”, the portable terminal adds the row index “1” to the virtual DB set. Further, when a plurality of DB files contains the data matching the DB search information, the portable terminal adds the respective row index and the DB file information including the row index, to the virtual DB set.

In step 209, the portable terminal determines whether the number of the row indexes in the virtual DB set is larger than 1.

When the virtual DB set includes one row index, the portable terminal opens the DB file including the row index, and displays one set of record (i.e., record set) corresponding to the row index in step 217. For example, when the DB file is generated as shown in Table 1 and the row index in the virtual DB set is “1”, the portable terminal extracts, stores, and displays Album=“A”, Genre=dance, and Artist=Joe in the corresponding DB file according to record set constitution information. Herein, the record set constitution information is provided from the application, and includes the type and the number of the keys in one record set and the format information of the record set. For example, when the DB file is generated as shown in Table 1, the type of the key includes Album, Genre and Artist.

When the virtual DB set includes a plurality of row indexes, the portable terminal extracts and displays the record set information according to the row index of the highest priority among the row indexes of the virtual DB set in step 211. For example, the priority order of the row index is determined by user of the portable terminal. Alternatively, the priority order of the row index is determined based on frequency of use of the row index. Here, if the user requests to modify the record set information, the portable terminal can modify the record set information displayed in the display unit by extracting the record set information of other row index according to a user's key manipulation.

In step 213, the portable terminal determines whether the user's manipulation selects any one record set of the row indexes.

When any one record set is selected, the portable terminal displays the selected record set in step 215.

Thereafter, the portable terminal finishes this process.

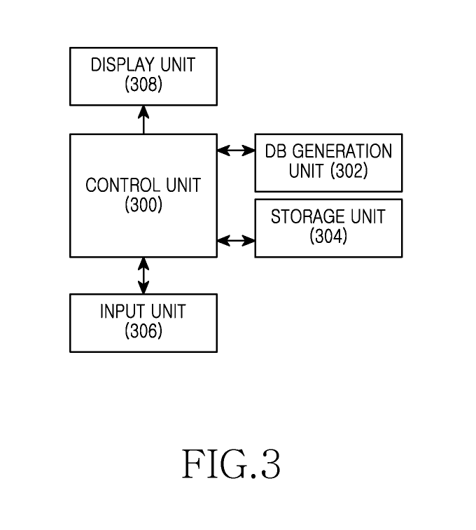

FIG. 3 is a block diagram of a portable terminal according to an exemplary embodiment of the present invention.

In FIG. 3, the portable terminal includes a control unit 300, a DB generation unit 302, a storage unit 304, an input unit 306, and a display unit 308.

The control unit 300 controls the operations of the portable terminal.

The control unit 300 controls the DB generation unit 302 to generate the DB file for the data provided from the input unit 306 or the application. Next, the control unit 300 controls to store the DB file generated by the DB generation unit 302 to the storage unit 304.

According to the DB search information provided from the input unit 306 or the application, the control unit 300 extracts and stores the corresponding record set. Here, the control unit 300 generates the virtual DB set as explained with reference to FIG. 2, and extracts and stores the record set of the corresponding row index.

The DB generation unit 302 generates the DB file under the control of the control unit 300. The DB generation unit 302 generates the DB file such that the number of the rows in one DB file does not exceed the reference row number. When the number of the rows in one DB file exceeds the reference row number, the DB generation unit 302 generates two or more DB files for the input data.

The storage unit 304 stores a program for controlling the portable terminal, temporary data generating in the terminal operation, system parameters, and other storable data. For example, the storage unit 304 stores the DB file under the control of the control unit 300. For example, the storage unit 304 stores the record set constitution information.

The input unit 306 provides data corresponding to the user's key input to the control unit 300. For example, the input unit 306 provides the control unit 300 with the data input from the user to generate the DB file. For example, the input unit 306 provides the DB search information input from the user, to the control unit 300.

The display unit 308 displays status information of the portable terminal, a character input by the user, a moving picture, and a still picture under the control of the control unit 300. For example, the display unit 308 displays the record set information selected by the user or the application under the control of the control unit 300.

As set forth above, since the portable terminal provides the DBMS service using the DB file which maps the keys and values in the one-to-one manner, the DBMS service can be available in the low-performance DB such as CDB.

Further, by limiting the number of the rows of the DB file in the portable terminal, it is possible to reduce the memory shortage in the portable terminal having the limited memory.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for providing a DataBase Management System (DBMS) service in a portable terminal having a limited memory, the method comprising:
when data base (DB) search information is input, determining a row index matching the DB search information from at least one DB file;
generating a virtual DB set having at least one row containing the DB search information; and
generating a record set by extracting data relating to the at least one row from the virtual DB set,
wherein the at least one DB file includes a table which maps one key and one value in a one-to-one manner.

2. The method of claim 1, further comprising:
generating the at least one DB file for input data.

3. The method of claim 3, further comprising:
determining whether a number of rows in the at least one DB file exceeds a predetermined number; and
if the number of rows exceeds the predetermined number, generating another DB file.

4. The method of claim 1, further comprising storing the generated virtual DB set.

5. The method of claim 1, further comprising displaying information of the record set.

6. The method of claim 1, further comprising:
when the virtual DB set comprise a plurality of rows, generating the record set by extracting data relating to at least one row according to predetermined criteria;
displaying information of the generated record set; and
storing the displayed record set.

7. The method of claim 6, further comprising:
when a user requests to change the displayed record set; and
changing the information of the displayed record set with information of the generated record set of the other row.

8. The method of claim 1, wherein the at least one DB file is generated as a Constant DB (CDB).

9. An apparatus for providing a DataBase Management System (DBMS) service in a portable terminal having a limited memory, comprising:
a data base (DB) generation unit for generating at least one DB file for input data;
a control unit for, when DB search information is input, determining a row indexmatching the DB search information from the at least one DB file, generating a virtual set comprising at least one row matching the DB search information, and generating a record set by extracting data relating to the at least one rowfrom the first virtual set; and
a storage unit for storing the at least one DB file generated by the DB generation unit, the virtual set, and the record set,
wherein the at least one DB file includes a table which maps one key and one value in a one-to-one manner.

10. The apparatus of claim 9, wherein the DB generation unit generates the at least one DB file to comprise at least one row not exceeding a reference number.

11. The apparatus of claim 9, wherein, when the row key matching the DB search information is from more than one DB file, the control unit generates the virtual set matching DB file information from the DB files.

12. The apparatus of claim 9, further comprising:
a display unit for displaying information of the record set.

13. The apparatus of claim 9, wherein, when the virtual set comprises a plurality of rows, the control unit generates the record set by extracting data relating to at least one row according to predetermined criteria, and controls to display information of the record set in a display unit, and
when a user selects the record set displayed in the display unit, the control unit controls to store the displayed record set.

14. The apparatus of claim 13, wherein when a user requests to change the displayed record set, the control unit controls to change the information of the record set with information of the generated record set of the other row.

15. The apparatus of claim 9, wherein the control unit generates the record set by extracting data relating to the at least one row of the virtual set.

16. The apparatus of claim 9, wherein the DB generation unit generates the at least one DB file as a Constant DB (CDB).
